(19) United States
(12) Patent Application Publication
(10) Pub. No.: US 2005/0188231 A1
(43) Pub. Date: Aug. 25, 2005

(54) Method and apparatus for indicating use state of SATA external storage device

(76) Inventor: Terng Huei Lai, Taipei City (TW)

Correspondence Address: TERNG HUEI LAI, 7F., No. 213 Civic Boulevard, Sec. 4, Taipei, 105, TW

(21) Appl. No.: 10/787,388

(22) Filed: Feb. 24, 2004

(51) Int. Cl. G06F 1/26

(52) U.S. Cl. 713/300

(57) ABSTRACT

A method for detecting and indicating use state of SATA external storage device includes the steps of (1) providing a SATA external storage device connected to a power input unit; (2) providing a driving circuit that is driven by changes in current flown therethrough, and is connected to and between the power input unit and a SATA storage unit of the SATA external storage device; and (3) providing an indicating circuit that is connected to and driven by the driving circuit. The driving circuit may be a transformer circuit, a relay circuit, or a voltage comparator circuit. The indicating circuit may be a light-emitting diode circuit, a liquid crystal display circuit, or other applied circuits. By utilizing changes in the current flown through the SATA storage unit performing different operations, it is possible to indicate the use state of the SATA external storage device.

### FIELD OF THE INVENTION

The present invention relates to a method and apparatus for indicating use state of a SATA external storage device, and more particularly to a method and apparatus in which a variation of current flown from a power input unit to a SATA storage unit of a SATA external storage device is utilized to induce an indicating circuit to operate and thereby indicate use state of the SATA external storage device.

### BACKGROUND OF THE INVENTION

Please refer to FIG. 1. In general personal computer architecture, the most common connecting interface for an external storage device 100, such as a hard disk, a CD-ROM, or a DVD, is provided through conversion of a USB interface or a 1394 interface (112 to 210) into an IDE interface 120. The IDE interface 120 is also referred to as the Parallel ATA Interface. When the power supply is not a consideration, IDE interface has 40 pins. An indicating circuit, such as a light-emitting diode (LED) or a bulb, is connected to the 39^{th} pin of the IDE interface 120. The external storage device 100 includes a storage unit 110 that uses the IDE interface 120 as a communication interface. When the external storage device 100 is connected to a personal computer 200 via the USB interface or the 1394 interface (112 to 210), signals between the personal computer 200 and the storage unit 110 are communicated via a bridge IC 113. When the personal computer 200 accesses data from the storage unit 110, a signal-indicating lamp 111 will flash to indicate the use state of the external storage device 100.

Since the IDE interface is designed for parallel communication, its transmission speed is limited to the range from 3.3 MB/sec to 133 MB/sec, which is almost impossible to increase anymore. Moreover, the use of flat cables having 40 pins or even 80 pins would cause poor installation and block heat ventilation. Therefore, a Serial ATA interface (SATA interface) that provides higher transmission speed and has the hot attach & detach ability has been developed. The transmission speed provided by the SATA interface is at least 1.5 Gb/sec (150 MB/sec) and may be as high as 3 Gb/sec. However, up to date, the SATA interface does not reserve a pin exclusively for the signal-indicating circuit. For the purpose to know the use state of a SATA external storage device, computer manufacturers have tried to provide an additional signal wire 220 extended from a host controller of the personal computer 200 to an indicating lamp 114 on an external storage device 110 using SATA interface 130 (hereinafter referred to as a SATA external storage device), as shown in FIG. 2. The storage unit 110 is powered via a power input unit 116. When the host controller controls the storage unit 110 to operate, it could provide a signal for the indicating lamp 114 to light. In the above-described way, the additional signal wire 220 between the external storage device 100 and the personal computer 200 is a must and would inevitably bring inconveniences to users.

FIG. 3 shows another relatively expensive solution for indicating the use state of the SATA external storage device. In this solution, a bridge IC 117 having a pin for the indicating circuit is connected to the SATA interface 130 for the storage unit 110. To the pin of the bridge IC 117 for the indicating circuit, an indicating lamp 118 is connected. When the personal computer 200 accesses data in the storage unit 110, the indicating lamp 118 connected to the pin of the bridge IC 117 for the indicating circuit flashes to indicate the use state of the external storage device 100. In this solution, since the expensive bridge IC functioning like a SATA-to-SATA repeater is required, most manufacturers cannot afford the high cost thereof.

It is therefore desirable to develop a simple method and apparatus for indicating use state of a SATA external storage device.

### SUMMARY OF THE INVENTION

A primary object of the present invention is to provide a method and apparatus that utilizes a variation of current flown from a power input unit to a SATA storage unit of a SATA external storage device to induce an indicating circuit to operate, so as to indicate the use state of the SATA external storage device via the indicating circuit at low cost. The problem existed in the conventional SATA external storage device of requiring high cost to indicate the use state of the SATA external storage device can therefore be solved.

Another object of the present invention is to provide a transformer circuit that is adapted to receive changes in current flown from the power input unit to the SATA storage unit in the SATA external storage device, and transforms the changes in current into a voltage for driving the indicating circuit to operate.

A further object of the present invention is to provide a relay circuit that is adapted to induce a magnetic force for controlling the on or off of a relay in response to the existence of any current flown from the power input unit to the SATA storage unit of the SATA external storage device, so as to detect the existence of the storage unit and serve as an indicating circuit allowing “hot attach and detach”.

A still further object of the present invention is to provide a voltage comparator circuit, which uses a resistance to detect changes in voltage between the power input unit and the SATA storage unit of the SATA external storage device, and then uses a comparator to control the indicating circuit.

The method of the present invention for detecting and indicating use state of a SATA external storage device mainly includes the steps of (1) providing a SATA external storage device connected to a power input unit; (2) providing a driving circuit that is driven by changes in current flown therethrough, and is connected to and between the power input unit and a SATA storage unit of the SATA external storage device; and (3) providing an indicating circuit that is connected to and driven by the driving circuit. The driving circuit may be a transformer circuit, a relay circuit, or a voltage comparator circuit. The indicating circuit may be a light-emitting diode circuit, a liquid crystal display circuit, or other applied circuits. By utilizing changes in the current flown through the SATA storage unit performing different operations, it is possible to indicate the use state of the SATA external storage device.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 schematically shows a first conventional apparatus for indicating the use state of an external storage device using IDE interface;

FIG. 2 schematically shows a second conventional apparatus for indicating the use state of a SATA external storage device;

FIG. 3 schematically shows a third conventional apparatus for indicating the use state of a SATA external storage device;

FIG. 4 schematically shows an apparatus according to the present invention for indicating the use state of a SATA external storage device;

FIG. 5 shows a first embodiment of the present invention, in which a comparator circuit is employed to drive an indicating circuit to indicate the use state of a SATA external storage;

FIG. 6 shows a second embodiment of the present invention, in which a relay circuit is employed to drive an indicating circuit to indicate the use state of a SATA external storage; and

FIG. 7 shows a third embodiment of the present invention, in which a transformer circuit is employed to drive an indicating circuit to indicate the use state of a SATA external storage.

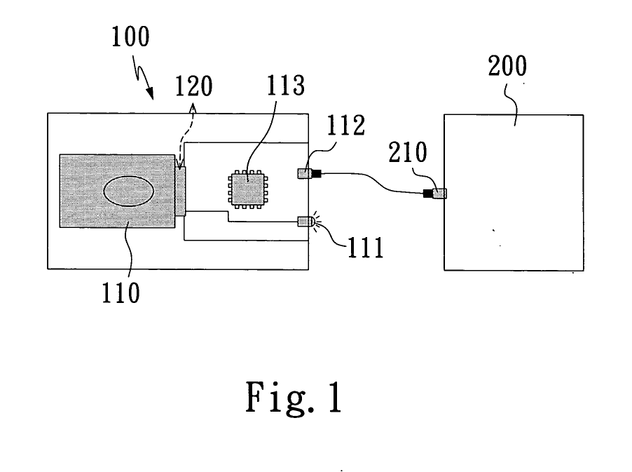

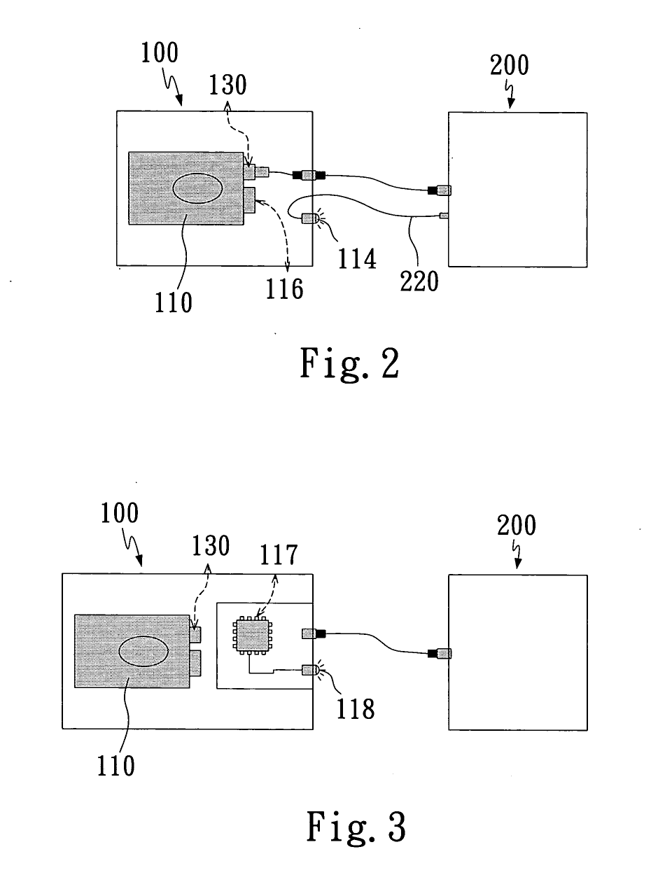

### DETAILED DESCRIPTION OF THE PREFERRED EMBODIMENTS

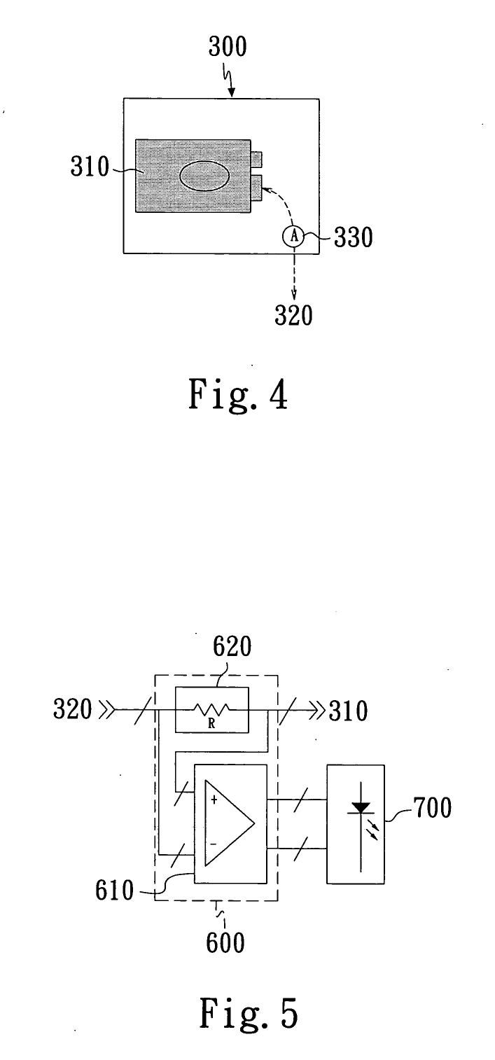

The present invention relates to a method for detecting and indicating use state of an SATA external storage device. Please refer to FIG. 4 that explains the theoretical basis of the present invention. A storage unit 310 of an external storage device 300 requires different amounts of current to perform different operations, such as reading and writing data. Therefore, a current measuring unit 330 may be provided between the storage unit 310 and a power input unit 320 to measure different amounts of current that flows to the storage unit 310 when different operations are being performed. From the changes in the current, it is possible to further detect the use state of the SATA external storage device 300. The following describes some different embodiments of the method of the present invention for detecting and indicating the use state of the SATA external storage device.

FIG. 5 shows a first embodiment of the present invention. In this embodiment, a comparator circuit 600 is connected between the storage unit 310 and the power input unit 320, and an indicating circuit 700 is connected to the comparator circuit 600. The indicating circuit 700 may be a light-emitting diode circuit or a liquid crystal display circuit. When the storage unit 310 reads or writes data, the power input unit 320 provides an amount of current that is required by the storage unit 310 to perform the reading or writing. When the supplied current flows through a resistance 620 of the comparator circuit 600, a comparator 610 of the comparator circuit 600 will compare voltages separately at front and rear ends of the resistance 620 and determines whether the indicating circuit 700 is to be driven. Thus, when the storage unit 310 operates, the light-emitting diode circuit or the liquid crystal display circuit forming the indicating circuit 700 will indicate the use state of the SATA external storage device 300.

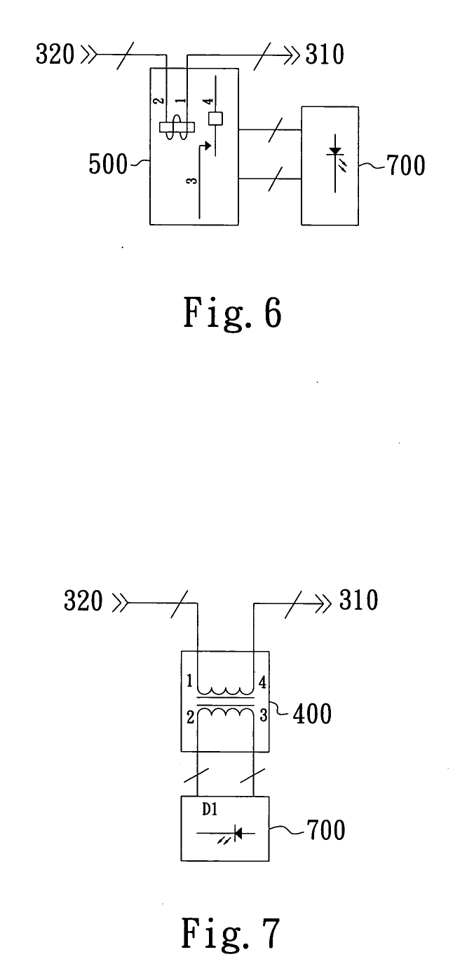

FIG. 6 shows a second embodiment of the present invention. In this embodiment, a relay circuit 500 is connected between the storage unit 310 and the power input unit 320, and an indicating circuit 700 is connected to the relay circuit 500. The indicating circuit 700 may be a light-emitting diode circuit or a liquid crystal display circuit. When the storage unit 310 is present, or plugged in, the power input unit 320 provides an amount of current that is required by the storage unit 310 to perform initialization and subsequent reading or writing. When the supplied current flows from the power input unit 320 to the storage unit 310 via the relay circuit 500, it is converted by the relay circuit 500 into a magnetic force needed to drive the relay circuit 500. When there is not current flown through the relay circuit 500, the relay circuit 500 will become an open circuit. Thus, when the storage unit 310 is present, the light-emitting diode circuit or the liquid crystal display circuit forming the indicating circuit 700 will indicate the presence of the SATA external storage device 300.

Finally, please refer to FIG. 7 that shows a third embodiment of the present invention. As shown, a transformer circuit 400 is connected between the storage unit 310 and the power input unit 320, and an indicating circuit 700 is connected to the transformer circuit 400. The indicating circuit 700 may be a light-emitting diode circuit or a liquid crystal display circuit. When the storage unit 310 reads or writes data, the power input unit 320 provides an amount of current that is required by the storage unit 310 to perform the reading or writing. When the supplied current flows from the power input unit 320 to the storage unit 310 via the transformer circuit 400, any change in the current is transformed by the transformer circuit 400 into a voltage needed to drive the indicating circuit 700. Thus, when the storage unit 310 operates, the light-emitting diode circuit or the liquid crystal display circuit forming the indicating circuit 700 will indicate the use state of the SATA external storage device 300.

In brief, the present invention utilizes changes in the current flown from a power source to the external storage device to induce an indicating circuit to operate, so that the use state of the SATA external storage device may be indicated at low cost without causing inconveniences to the user.

The present invention has been described with some preferred embodiments thereof and it is understood that many changes and modifications in the described embodiments can be carried out without departing from the scope and the spirit of the invention that is intended to be limited only by the appended claims.

1. A method for detecting and indicating use state of SATA external storage device, comprising the steps of:
providing a SATA external storage device connected to a power input unit;
measuring a variation of current flown from said power input unit to an SATA storage unit of said SATA external storage device;
using said variation of current to drive a driving circuit; and
using an indicating circuit to indicate said variation of current at said driving circuit and thereby indicating a use state of said SATA external storage device.

2. The method for detecting and indicating use state of SATA external storage device as claimed in claim 1, wherein said driving circuit is a transformer circuit, which receives said variation of current flown from said power input unit to said SATA storage unit of said SATA external storage device and transforms said variation of current into a voltage adapted to drive said indicating circuit to operate.

3. The method for detecting and indicating use state of SATA external storage device as claimed in claim 1, wherein said driving circuit is a relay circuit, which is adapted to induce a magnetic force for controlling the on or off of a relay in response to the existence of any current flown from said power input unit to said SATA storage unit of said SATA external storage device.

4. The method for detecting and indicating use state of SATA external storage device as claimed in claim 1, wherein said driving circuit is a voltage comparator circuit, which uses a resistance to detect changes in voltage between said power input unit and said SATA storage unit of said SATA external storage device, and then uses a comparator to control the on or off of said indicating circuit.

5. An apparatus for detecting and indicating use state of SATA external storage device, comprising:
a power input unit;
a serial ATA (SATA) external storage device electrically connected to said power input unit;
a driving circuit connected to and between said power input unit and a SATA storage unit in said SATA external storage device to be driven by a variation of current; and
an indicating circuit electrically connected to and driven by said driving circuit.

6. The apparatus for detecting and indicating use state of SATA external storage device as claimed in claim 5, wherein said driving circuit is a transformer circuit, which receives said variation of current flown from said power input unit to said SATA storage unit of said SATA external storage device, and transforms said variation of current into a voltage adapted to drive said indicating circuit to operate.

7. The apparatus for detecting and indicating use state of SATA external storage device as claimed in claim 5, wherein said driving circuit is a relay circuit, which is adapted to induce a magnetic force for controlling the on or off of a relay in response to the existence of any current flown from said power input unit to said SATA storage unit of said SATA external storage device.

8. The apparatus for detecting and indicating use state of SATA external storage device as claimed in claim 5, wherein said driving circuit is a voltage comparator circuit, which uses a resistance to detect changes in voltage between said power input unit and said SATA storage unit of said SATA external storage device, and then uses a comparator to control the on or off of said indicating circuit.
